(19) United States
(12) Patent Application Publication
(10) Pub. No.: US 2017/0167882 A1
(43) Pub. Date: Jun. 15, 2017

(54) SYSTEM AND METHOD FOR GENERATING AVAILABLE RIDE-SHARE PATHS IN A TRANSPORTATION NETWORK

(71) Applicant: Xerox Corporation, Norwalk, CT (US)

(72) Inventors: Luis Rafael Ulloa Paredes, Meylan (FR); César Roberto De Souza, Grenoble (FR)

(73) Assignee: Xerox Corporation, Norwalk, CT (US)

(21) Appl. No.: 14/963,543

(22) Filed: Dec. 9, 2015

(51) Int. Cl. G01C 21/34; G01C 21/20

(52) U.S. Cl. CPC G01C 21/3446; G01C 21/20; G01C 21/3423; G01C 21/3453

(57) ABSTRACT

This disclosure provides a method and system for generating one or more available paths from a rider origin location to a rider destination location using a trip planning platform. The generated available paths include, at least in part, a rider-sharing route. According to an exemplary system, the transportation network includes one or more fixed routes of transportation associated with one or more of buses, trains, bikes, walking paths and trams.

### CROSS REFERENCE TO RELATED PATENTS AND APPLICATIONS

U.S. patent application Ser. No. 14/450,628, filed Aug. 4, 2014, by Ulloa Paredes, entitled “EFFICIENT ROUTE PLANNING IN PUBLIC TRANSPORTATION NETWORKS”, and

U.S. patent application Ser. No. 14/837,070, filed Aug. 27, 2015, by Koyel Mukherjee et al., entitled “METHOD AND SYSTEM FOR SCHEDULING VEHICLES ALONG ROUTES IN A TRANSPORTATION SYSTEM” are incorporated herein by reference in their entirety.

### BACKGROUND

Ride sharing has become a very interesting topic recently. With the advent of new, popular mobile phone applications and their associated companies such as Uber®, Lyft® and Blablacar® users are now capable of surpassing conventional public transport companies and their decade-old methodologies. Now, instead of being simple passive customers of those companies, users now have been able to invert their role and simultaneously act as both transport service customers and transport service providers.

Unsurprisingly, this change of paradigm on transportation has been made possible through technology. Easy-to-use mobile applications have granted users way to announce, on-the-spot and on-the-fly, where they would like to go. Intelligent systems then attempt to match users demanding such services with users willing to provide such services, providing a win-win situation for both sides.

These intelligent systems are however not magical, and instead rely on often simplistic algorithms that are non-optimal-at-all to perform this matching. Worse, some systems rely on the simple announcement, by the user, about places that could be visited during their trip; but those systems have no knowledge on how elastic the driver preferences could be. For example, perhaps a driver could make double the profit if he passed through a slightly different route than the one he announced; and as well a user could find much more interesting ride matches if the driver showed up 5 minutes before or after the period specified by the driver on the ride-sharing system.

The current reality of ride sharing systems insofar have typically presented limited scale, local search and matching systems that can only operate in the range of tenths to hundred users, see GHOSEIRI, “DYNAMIC RIDESHARE OPTIMIZED MATCHING PROBLEM”, University of Maryland, Civil Engineering; College Park: Digital Repository at the University of Maryland; chapters 1-3, 2012, a problem involving one user performing a request against 14 possible drivers in 400 square miles, although with extensive user profile matching capabilities, is considered a medium-sized task. However, for the best of our knowledge, no known system can propose potential rides, as well as suggestions on how to arrive to possible meeting points taking multiple transport options into account, for potentially hundreds of thousands of users in a city.

As such, the problem is then: given a set of users who are already going from A to B, and a set of users who would like to go from X to Y, where the path that goes from X to Y is a potential sub-path of going from A to B, how do we identify matches between those two groups of users in an optimal way and in a reasonable amount of time?

### INCORPORATION BY REFERENCE

Mukherjee et al. (2014); Static and Dynamic Routing and Scheduling of Shared Transport;

U.S. patent application Ser. No. 14/450,628, filed Aug. 4, 2014, by Ulloa Paredes, entitled “EFFICIENT ROUTE PLANNING IN PUBLIC TRANSPORTATION NETWORKS”;

U.S. Patent Publication No. US2011/0313880, Published Dec. 22, 2011, by Paul et al., entitled “SYSTEM AND METHOD FOR SELECTING TRANSPORTATION RESOURCES”;

U.S. Patent Publication No. US2012/0239452, published Sep. 20, 2012, by Trivedi et al., entitled “FLEET MANAGEMENT SYSTEMS AND PROCESSES”;

U.S. Patent Publication No. US2013/0132140, Published May 23, 2013, by Amin et al., entitled “DETERMINING A LOCATION RELATED TO ON-DEMAND SERVICES THROUGH USE OF PORTABLE COMPUTING DEVICES”;

U.S. Patent Publication No. US2013/0132887, Published May 23, 2013, by Amin et al., entitled “TRANSITIONING USER INTERFACE FEATURES FOR ON-DEMAND SERVICES THROUGH USE OF PORTABLE COMPUTING DEVICES”;

U.S. Patent Publication No. US2013/0246207, Published Sep. 19, 2013, by Novak et al., entitled “SYSTEM AND METHOD FOR DYNAMICALLY ADJUSTING PRICES FOR SERVICES”;

U.S. Patent Publication No. US2013/0246301, Published Sep. 19, 2013, by Radhakrishnan et al., entitled “PROVIDING USER FEEDBACK FOR TRANSPORT SERVICES THROUGH USE OF MOBILE DEVICES”;

U.S. Patent Publication No. US2014/0129135, Published May 8, 2014, by Holden et al., entitled “DYNAMICALLY PROVIDING POSITION INFORMATION OF A TRANSIT OBJECT TO A COMPUTING DEVICE”;

U.S. Patent Publication No. US2014/0129302, Published May 8, 2014, by Amin et al., entitled “PROVIDING A CONFIRMATION INTERFACE FOR ON-DEMAND SERVICES THROUGH USE OF PORTABLE COMPUTING DEVICES”;

U.S. Patent Publication No. US2014/0129951, Published May 8, 2014, by Amin et al., entitled “PROVIDING ON-DEMAND SERVICES THROUGH USE OF PORTABLE COMPUTING DEVICES”;

U.S. Pat. No. 6,356,838, issued Mar. 12, 2002, by Paul, entitled “SYSTEM AND METHOD FOR DETERMINING AN EFFICIENT TRANSPORTATION ROUTE”;

U.S. Pat. No. 8,977,496, issued Mar. 10, 2015, by Ulloa Paredes et al., entitled “SYSTEM AND METHOD FOR ESTIMATING ORIGINS AND DESTINATIONS FROM IDENTIFIED END-POINT TIME-LOCATION STAMPS;

ALBA et al., “Computing nine new best-so-far solutions for Capacitated VRP with a cellular Genetic Algorithm”, April, 2004, pages 225-230;

BOURGEOIS et al., “AN EXTENSION OF THE MUNKRES ALGORITHM FOR THE ASSIGNMENT PROBLEM TO RECTANGULAR MATRICES”, Communications of the ACM, December, 1971, Volume 14, Number 12, pages 802-804;

CHEN et al., “TWO-STAGE STOCHASTIC NATURAL LANGUAGE GENERATION FOR EMAIL SYNTHESIS BY MODELING SENDER STYLE AND TOPIC STRUCTURE”, June, 2014, pages 152-156;

DUPUIS et al., “LOGICAL ANALYSIS OF DATA FOR ESTIMATING PASSENGER SHOW RATES AT AIR CANADA”, Journal of Air Transport Management, 2012, 78-81;

FERGUSON, “WHO SOLVED THE SECRETARY PROBLEM?”, Statistical Science, Vol. 4, No. 3, August, 1989, pages 282-289;

GHOSEIRI, “DYNAMIC RIDESHARE OPTIMIZED MATCHING PROBLEM”, University of Maryland, Civil Engineering; College Park: Digital Repository at the University of Maryland; chapters 1-3, 2012;

MUNKRES, “ALGORITHMS FOR THE ASSIGNMENT AND TRANSPORTATION PROBLEMS”, Journal of the Society for Industrial and Applied Mathematics; Vol. 5, No. 1, March, 1957, pages 31-38;

RUBINO et al., “TOPIC MODELS FOR TRANSLATION QUALITY ESTIMATION FOR GISTING PURPOSES”, 8 pages, Machine Translation Archive, 2013, http://www.mt-archive.info/srch/;

SANTOS et al., “DYNAMIC TAXI AND RIDESHARING: A FRAMEWORK AND HEURISTICS FOR THE OPTIMIZATION PROBLEM”, Proceedings of the Twenty-Third International Joint Conference on Artificial Intelligence, 2013, pages 2885-2891;

WANG, “OPTIMIZING RIDE MATCHES FOR DYNAMIC RIDE-SHARING SYSTEMS”, Georgia Institute of Technology, Industrial and Systems Engineering, Atlanta, May, 2013, Chapters 1-3;

XIONG et al., “A TOPIC-BASED COHERENCE MODEL FOR STATISTICAL MACHINE TRANSLATION”, Proceedings of the Twenty-Seventh AAAI Conference on Artificial Intelligence, 7 pages, are incorporated herein by reference in their entirety.

### BRIEF DESCRIPTION

In one embodiment of this disclosure, described is a method for generating one or more available paths from a rider origin location to a rider destination location using a trip planning platform, the available paths including, at least in part, a ride-sharing route and the trip planning platform configured to generate one or more paths associated with a transportation network including one or more fixed routes of transportation associated with one or more of buses, trains, bikes, walking paths and trams, the method comprising: a) receiving, by a processing device, ride-share information from a driver offering to ride-share, the ride-share information including a driver desired departure location and time/date, and a driver desired arrival location and time/date; b) mapping, by the processing device, the ride-share information to virtual vehicle routes within the transportation network including one or more ride-share fixed routes, each of the ride-share fixed routes associated with the driver desired departure location and driver desired departure time/date, and the driver desired arrival location and driver desired arrival date/time; c) receiving, by the processing device, a request from a potential rider to determine one or more available paths between a rider origin location and a rider destination location desired by the potential rider within the transportation network; and d) generating, by the processing device, the one or more available paths within the transportation network, the one or more available paths including one or more of the virtual vehicle routes and the one or more available paths associated with available paths that are calculated to have a minimal cost, the cost associated with one of arrival time of the potential rider at the rider destination location, duration of travel of the potential rider to the rider destination location, number of routes associated with travel of the potential rider to the rider destination location, distance of travel of the potential rider to the rider destination location, and monetary cost of travel of the potential rider to the rider destination location.

In another embodiment of this disclosure, described is a ride-sharing path generation system comprising: a trip planning platform configured to generate one or more paths associated with a transportation network including one or more fixed routes of transportation associated with one or more of buses, trains, bikes, walking paths and trams; a driver ride-share information receiving component configured to receive ride-share information from one or more drivers offering to ride-share, the ride-share information including a driver desired departure location and time/date, and a driver desired arrival location and time/date; a virtual vehicle mapping component configured to map the ride-share information to virtual vehicle routes within the transportation network including one or more ride-share fixed routes, each of the ride-share fixed routes associated with the driver desired departure location and driver desired departure time/date, and the driver desired arrival location and driver desired arrival date/time; a rider request component configured to receive a request from a potential rider to determine one or more available paths between a rider origin location and a rider destination location desired by the potential rider within the transportation network; and a path generation component configured to generate the one or more available paths within the transportation network, the one or more available paths including one or more of the virtual vehicle routes and the one or more available paths associated with available paths that are calculated to have a minimal cost, the cost associated with one of arrival time of the potential rider at the rider destination location, duration of travel of the potential rider to the rider destination location, number of routes associated with travel of the potential rider to the rider destination location, distance of travel of the potential rider to the rider destination location, and monetary cost of travel of the potential rider to the rider destination location.

In still another embodiment of this disclosure, described is a method for generating one or more available paths from a plurality of rider origin locations to a plurality of respective rider destination location using a trip planning platform, the available paths including, at least in part, a ride-sharing route and the trip planning platform configured to generate one or more paths associated with a transportation network including one or more fixed routes of transportation associated with one or more of buses, trains, bikes, walking paths and trams, the method comprising: a) receiving, by a processing device, ride-share information from a plurality of drivers offering to ride-share, the ride-share information including, for each driver, a driver desired departure location and time/date, and a driver desired arrival location and time/date; b) mapping, by the processing device, the ride-share information to virtual vehicle routes within the transportation network including one or more ride-share fixed routes, each of the ride-share fixed routes associated with a respective driver desired departure location and driver desired departure time/date, and the driver respective desired arrival location and driver desired arrival date/time; c) receiving, by the processing device, a request from a plurality of potential riders to determine one or more available paths between a rider origin location and a rider destination location desired by each of the respective potential riders within the transportation network; and d) generating, by the processing device, the one or more available paths within the transportation network, the one or more available paths including one or more of the virtual vehicle routes and the one or more available paths associated with available paths that are calculated to have a minimal cost, the cost associated with one of arrival time of the potential rider at the rider destination location, duration of travel of the potential rider to the rider destination location, number of routes associated with travel of the potential rider to the rider destination location, distance of travel of the potential rider to the rider destination location, and monetary cost of travel of the potential rider to the rider destination location.

In yet another embodiment of this disclosure, described is a ride-sharing path generation system comprising: a trip planning platform configured to generate one or more paths associated with a transportation network including one or more fixed routes of transportation associated with one or more of buses, trains, bikes, walking paths and trams; a driver ride-share information receiving component configured to receive ride-share information from a plurality of drivers offering to ride-share, the ride-share information including, for each driver, a driver desired departure location and time/date, and a driver desired arrival location and time/date; a virtual vehicle mapping component configured to map the ride-share information to virtual vehicle routes within the transportation network including one or more ride-share fixed routes, each of the ride-share fixed routes associated with a respective driver desired departure location and driver desired departure time/date, and the respective driver desired arrival location and driver desired arrival date/time; a rider request component configured to receive a request from a plurality of potential riders to determine one or more available paths between a rider origin location and a rider destination location desired by each of the respective potential riders within the transportation network; and a path generation component configured to generate the one or more available paths within the transportation network, the one or more available paths including one or more of the virtual vehicle routes and the one or more available paths associated with available paths that are calculated to have a minimal cost, the cost associated with one of arrival time of the potential rider at the rider destination location, duration of travel of the potential rider to the rider destination location, number of routes associated with travel of the potential rider to the rider destination location, distance of travel of the potential rider to the rider destination location, and monetary cost of travel of the potential rider to the rider destination location.

### BRIEF DESCRIPTION OF THE DRAWINGS

FIG. 1 is a flowchart of a method for generating available paths from a rider origin location to a rider destination location using a trip planning platform according to an exemplary embodiment of this disclosure.

FIG. 2 is a block diagram of a ride-sharing path generation system according to an exemplary embodiment of this disclosure.

FIG. 3 illustrates an example of a Limited Capacity Vehicle Routing Problem.

FIG. 4 illustrates a conventional understanding of supply and demand for public transport models (tap), and supply and demand for an extended public transport model according to an exemplary embodiment of this disclosure.

FIG. 5A is an infographic illustrating the generation of an augmented public transportation network according to an exemplary embodiment of this disclosure.

FIG. 5B is an infographic illustrating the use of the augmented public transport network generated in FIG. 5A to provide a solution to a user matching problem associated with a dynamic multimodal ride-sharing according to an exemplary embodiment of this disclosure.

FIG. 6 illustrates how virtual paths can be generated in batches sequentially from a set of valid waypoints for each driver, according to an exemplary embodiment of this disclosure.

FIG. 7 is a flowchart of a sequential process for schedule generation and ride-share matching according to an exemplary embodiment of this disclosure.

FIG. 8 is a flowchart of a parallel process for schedule generation and ride-share matching according to an exemplary embodiment of this disclosure.

FIG. 9 illustrates a shortest and alternative path generated considering only public transport options, associated with an example public transport network scenario.

FIG. 10 illustrates a shortest path for the scenario of FIG. 9, where ride-sharing is considered in addition to public transport options.

FIG. 11 illustrates an alternative path for the scenario of FIG. 10, where ride-sharing is considered in addition to public transport options.

FIG. 12 is a graphical representation of the distribution of minutes saved when a trip planning system suggests only one possible ride-share journey, i.e., path, per trip planning request.

FIG. 13 is a graphical representation of the distribution of minutes saved when a trip planning system suggests multiple possible ride-share journeys per trip planning request.

FIG. 14 is a graphical representation of the distribution of minutes saved when a trip planning system suggests multiple possible ride-share journeys per trip planning request, where ride-share vehicles can transport up to 8 passengers.

FIG. 15 is a graphical representation of the distribution of cumulated minutes saved by passengers in a vehicle when a trip planning system suggests multiple possible ride-share journeys per trip planning request.

FIG. 16 is an example of a driver interface to announce ride-share information to a trip planning system according to an exemplary embodiment of this disclosure.

FIG. 17 is an example of a potential rider interface which generates an available path including a ride-share route, as announced by a driver in FIG. 15, according to an exemplary embodiment of this disclosure.

### DETAILED DESCRIPTION

In this disclosure, the vehicle ride sharing problem discussed in the background is solved by casting the vehicle ride sharing scenario as an augmented trip planning problem using a trip planning framework as disclosed in co-pending U.S. patent application Ser. No. 14/450,628, filed Aug. 4, 2014, by Ulloa Paredes, entitled “EFFICIENT ROUTE PLANNING IN PUBLIC TRANSPORTATION NETWORKS”. A trip planning system is expanded to include ride-sharing, becoming then able to approximate optimal solutions for this problem in city-sized dimensions. So far, existing systems and approaches can only approximate those decisions for diminished, local decisions. The disclosed system, in turn, leverages an existing trip planning framework to find the best decisions in the context of a city.

Some aspects of the disclosed method and system include techniques to (1) transform the dynamic ride sharing matching problem to a trip planning domain, and then (2) solve the mapped problem as a sequence of constrained optimization steps. Other existing systems handle this problem as a single, very large optimization problem solved through integer programming. See WANG, “OPTIMIZING RIDE MATCHES FOR DYNAMIC RIDE-SHARING SYSTEMS”, Georgia Institute of Technology, Industrial and Systems Engineering, Atlanta, May, 2013, Chapters 1-3; GHOSEIRI, “DYNAMIC RIDESHARE OPTIMIZED MATCHING PROBLEM”, University of Maryland, Civil Engineering; College Park: Digital Repository at the University of Maryland; chapters 1-3, 2012; and U.S. Patent Publication No. US2013/0246301, Published Sep. 19, 2013, by Radhakrishnan et al., entitled “PROVIDING USER FEEDBACK FOR TRANSPORT SERVICES THROUGH USE OF MOBILE DEVICES”. Whereas these approaches are also valid, the burden of trying to solve very large integer programming problems restricts the approach described in the aforementioned works to consider only static routes between travel stops. The sequential and parallel approaches described herein generate virtual schedules to feed a trip-planning system, allowing the consideration of not only fixed routes between travel stops, but also fully dynamic routes.

The disclosed trip-planning augmentation method and system also includes a system implementing the method presented here to consider fully multi-modal routes, in which a passenger can, for example, switch from a bus to a ride-share vehicle and then take a tram to finish a trip, if that would be the most convenient way to fulfill the journey. The method presented here also takes into consideration several alternative routes between stops and provides an efficient method to reach approximately optimal solutions for the joint dynamic-ride-sharing-plus-transport-planning scenario. The system described herein has been tested and verified to work with 5000 distinct passenger announcements, 1500 stop points and at least 1500 vehicles.

The method and system described herein can be viewed as a way to optimize the number, the length, or the duration, of travels that would be needed to transfer an entity from one location point to another location point considering a large number of available transport agents simultaneously. For example, the methodology described herein can be used to incorporate the transport of goods in a public transport network. This may be appealing for transport companies that rely on non-conventional distribution posts, which are usually small to medium commercial establishments, such as small retail shops.

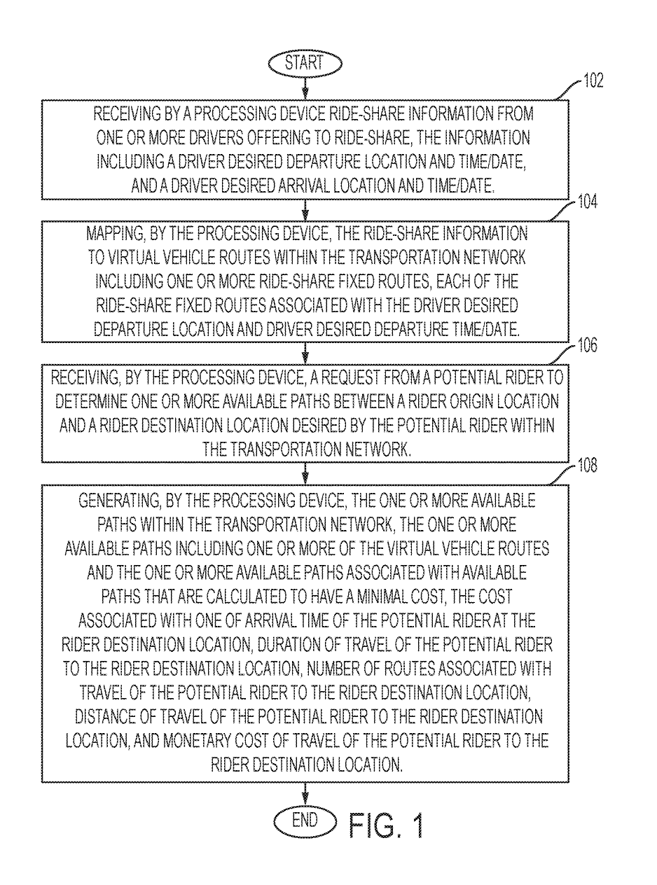

With reference to FIG. 1, shown is a flowchart of a method for generating available paths from a rider origin location to a rider destination location using a trip planning platform according to an exemplary embodiment of this disclosure.

The method includes the following steps:

a) Receiving by a processing device ride-share information from one or more drivers offering to ride-share, the information including a driver desired departure location and time/date, and a driver desired arrival location and time/date 102.

b) Mapping, by the processing device, the ride-share information to virtual vehicle routes within the transportation network including one or more ride-share fixed routes, each of the ride-share fixed routes associated with the driver desired departure location and driver desired departure time/date, and the driver desired arrival location and driver desired arrival date/time 104.

c) Receiving, by the processing device, a request from a potential rider to determine one or more available paths between a rider origin location and a rider destination location desired by the potential rider within the transportation network 105.

d) Generating, by the processing device, the one or more available paths within the transportation network, the one or more available paths including one or more of the virtual vehicle routes and the one or more available paths associated with available paths that are calculated to have a minimal cost, the cost associated with one of arrival time of the potential rider at the rider destination location, duration of travel of the potential rider to the rider destination location, number of routes associated with travel of the potential rider to the rider destination location, distance of travel of the potential rider to the rider destination location, and monetary cost of travel of the potential rider to the rider destination location 106.

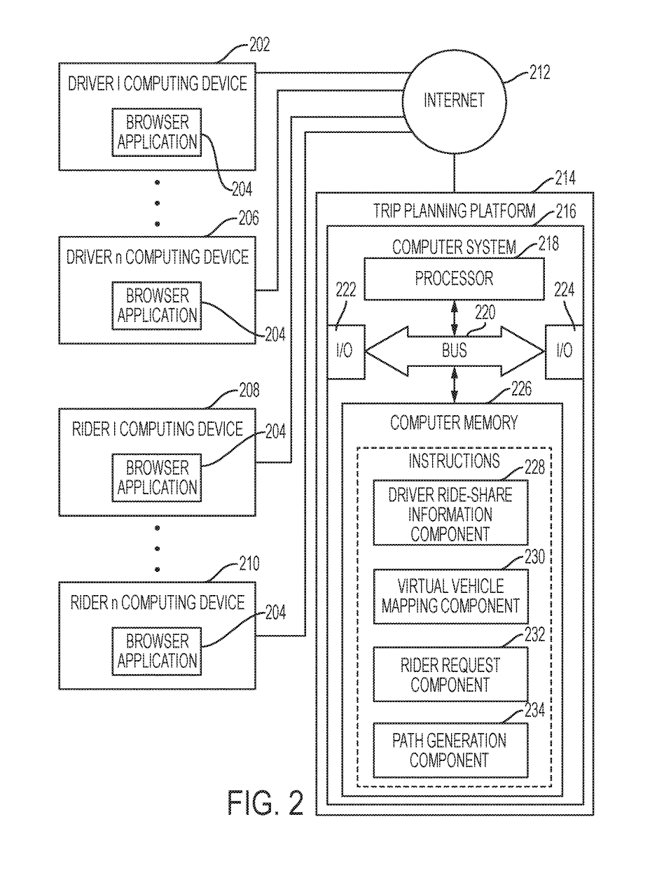

With reference to FIG. 2, shown is a block diagram of a ride-sharing path generation system according to an exemplary embodiment of this disclosure.

The ride-sharing path generation system includes the following components.

A trip planning platform 214 is configured to generate one or more paths associated with a transportation network including one or more fixed routes of transportation associated with one or more of buses, trains, bikes, walking paths and trams, in addition to virtual vehicle routes, i.e., ride-share rates. The trip planning platform 214 includes a computer system 216 with one or more processors 218, a communication bus 220 and one or more input-output modules 222, 224. The communication bus 220 operatively communicates with computer memory 226 to execute computer readable instructions to generate the one or more paths.

The computer memory 226 includes a driver ride-share information receiving component 228, a virtual vehicle mapping component 230, a rider request component 232 and a path generation component 234. The driver ride-share information receiving component 228 is configured to receive ride-share information from one or more drivers offering to ride-share, the information including a driver desired departure location and time/date, and a driver desired arrival location and time/date. The virtual vehicle mapping component 230 is configured to map the ride-share information to virtual vehicle routes within the transportation network including one or more ride-share fixed routes, each of the ride-share fixed routes associated with the driver desired departure location and driver desired departure time/date, and the driver desired arrival location and driver desired arrival date/time. The rider request component 232 is configured to receive a request from a potential rider to determine one or more available paths between a rider origin location and a rider destination location desired by the potential rider within the transportation network. The path generation component 234 is configured to generate the one or more available paths within the transportation network, the one or more available paths including one or more of the virtual vehicle routes and the one or more available paths associated with available paths that are calculated to have a minimal cost, the cost associated with one of arrival time of the potential rider at the rider destination location, number of routes associated with travel of the potential rider to the rider destination location, distance of travel of the potential rider to the rider destination location, and monetary cost of travel of the potential rider to the rider destination location.

The Trip Planning Platform 214 communicates over a communication network, i.e., internet 212, with one or more drivers using Driver Computing Devices 202 through 206 which run browser applications 204 to provide an interface with the drivers to announce their availability as a ride-share driver, in addition to information, such as, their desired or intended departure location and time/date, and their desired or intended arrival location and time/date.

The Trip Planning Platform 214 also communicates over communication network 212 with one or more riders using Rider Computing Devices 208 through 210 with browser application 204 to provide an interface with the riders for requesting the generation of available paths between the rider origin location and rider destination location, including virtual vehicle routes associated with one or more ride-share drivers. In addition, the browser application 204 communicates with the Trip Planning Platform to display to the rider the generated available paths, as well as functionality to enable a rider to accept a displayed available path.

This disclosure, and the exemplary embodiments described, tackles a most fundamental problem of dynamic ride sharing, which is to match potential passengers and potential drivers by taking into account their announced trips considering only the drivers' departure and arrival places and the drivers' intended departure and arrival times. This disclosure and the exemplary methods and systems provided herein demonstrate how to solve this fundamental problem. While the exemplary method and system described herein does not consider profile preferences for each user, such as differentiating between smokers and non-smokers, whether people tolerate pets, whether people would prefer to travel only with people with the same gender, and others.

Profile preferences can be addressed as a post-processing step. Notably, profile matching is not required to be completed with all possible drivers and travel possibilities, but simply against those drivers whose trips could have been matched. As such, the problem space decreases significantly, and finding profile matches between potential drivers can be reduced as a secondary, although still possibly important, problem in the ride-matching scenario.

Stated another way, the method and system described herein can be used to give approximate optimum solutions for the dynamic ride sharing problem (DRSP). This problem is also known as on-demand ride sharing, dynamic car-pooling, or instant ride sharing.

This problem, in the most simple of the terms, is simply the problem of finding someone who is passing nearby with a car and would be willing to give someone else a ride to some location, at some price. The problem has two different, competing façades: One comes from the viewpoint of a passenger who is willing to pay to be transported from one location point to another location point. Another comes from the viewpoint of the driver, who is willing to go from one location point to another location point for a price. A typical user, i.e., rider, would be willing to use such service in the hope they could pay less, while the driver, on the other hand, may be willing to ride-share to make a profit from the service.

The sweet spot of this problem lies where these two aspects match. In other words, both the driver and the passenger's interests must coincide according to multiple criteria, such as the locations, the times, and the price. Furthermore, those matches must be found in an extremely limited short time, i.e., the solution must be dynamically provided. Driver-Rider matches need to be determined as soon as possible so the user experience can match the same experience of a competing traditional system, such as those from a traditional taxi company.

The dynamic ride sharing problem is a NP-hard (non-deterministic polynomial-time hard) problem. See SANTOS et al., “DYNAMIC TAXI AND RIDESHARING: A FRAMEWORK AND HEURISTICS FOR THE OPTIMIZATION PROBLEM”, Proceedings of the Twenty-Third International Joint Conference on Artificial Intelligence, 2013, pages 2885-2891. For example, finding route matches in space and time is a combinatorial problem for which exact solutions are still unknown, if they exist at all. Now, this problem is augmented to consider other aspects, such as for example that every vehicle can only take a limited number of passengers, the problem becomes only more complex.

As such, to expose this complexity and how the disclosed approach works, a simpler vehicle routing problem is initially described and then the dynamic and car-sharing aspects are added.

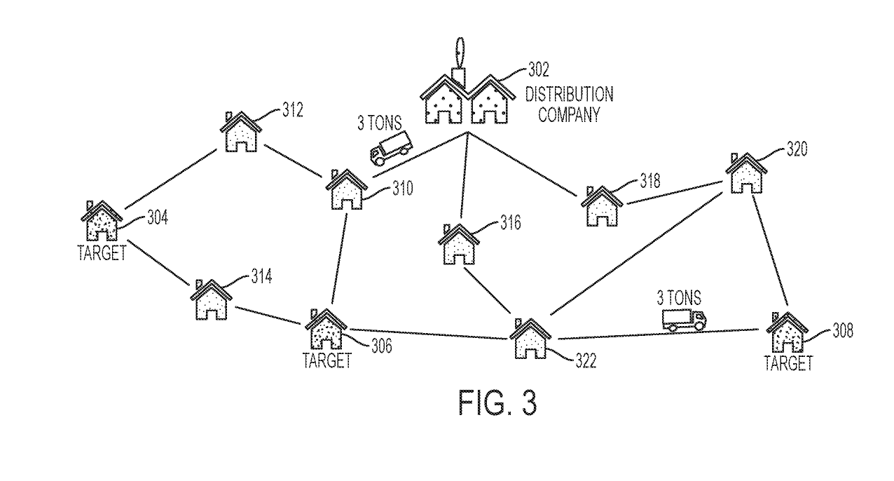

The Vehicle Routing Problem is a fundamental combinatorial problem in the logistics and transportation fields. In one of its simplest forms, this problem consists of trying to determine the shortest routes one can deliver something using vehicles with a limited capacity. With reference to FIG. 3, such problems are problems that can be stated in the following form:

“Given a company 302 with two trucks that can transport 3 tons each, what would be the best way of transporting 5 tons over 3 distinct destinations 304, 306 and 308?”, where the routes must go through one or more of a group of way points 310, 312, 314, 316, 318, 320 and 322.

For m vehicles and k stops, this problem can be expressed as the problem of finding a set of routes \vec{S} that provide a minimal global cost solution F(\vec{S}) defined by

F(\vec{S})=Σᵢ₌₁^{m} C(\vec{R}ᵢ) (Eq. 1)

in which

C(\vec{R}ᵢ)=Σⱼ₌₀^{k} c_{j,j+1}+Σⱼ₌₀^{k} δⱼ. (Eq. 2)

and \vec{R}ᵢ is the ith route, c_{j,j+1} is the cost between stops, and δⱼ is the cost to unload the goods at each stop. (See Enrique Alba, 2005.) Moreover, the solution must be found under the constraints that solution routes must begin and end in the vehicle depot; each customer receiving goods only once per vehicle, the vehicle cannot transport more than its capacity, and the vehicle cannot travel more than a given distance.

Notably, this is one of the simplest instances of the vehicle routing problem, and state of the art solutions have not yet been able to obtain optimal solutions even for relatively small-sized problems. For instance, Breedam's, struggles to find solutions for 100 customers with a total demand of 1000 units benchmark. See ALBA et al., “Computing nine new best-so-far solutions for Capacitated VRP with a cellular Genetic Algorithm”, April, 2004, pages 225-230.

Considered now are the following other categories of routing problems of increasing complexity where category 1 is the least complex and category 10 is the most complex. Each category builds on the previous, adding another layer of complexity. This will provide a framework to understand how the dynamic car-ride sharing problem fares amongst its related problems.

1. Capacity Vehicle Routing: the aforementioned problem described above;

2. Multiple Depot Capacity Vehicle Routing: same as category 1 with the addition of multiple starting and ending vehicle depots;

3. Capacity Vehicle Routing with pick-ups and deliveries: same as category 2 adding stop points now acting as depots and the ability to load and unload vehicles at each stop point. Considering the capacity of the vehicle as measured by the number of passengers the vehicle can transport, this is equivalent to making pick-ups and drop-offs at each stop;

4. Capacity Vehicle Routing with pick-ups, deliveries and destinations: same as category 3 adding the destination of the vehicle is different for each vehicle;

5. CVRP with pick-ups, deliveries, destinations and time windows: same as category 4 adding the pick-ups and deliveries need to be made during certain time windows;

6. CVRP with pick-ups, deliveries, destinations, time windows and good-transfers: same as category 5 adding the unitary goods can be transferred to reach their final destination;

7. Dynamic Ride Sharing Problem (DRSP): same as category 6 adding each good is now a passenger being transported so that the optimization must now also consider the cost from the point of view of each person, also supply, demand and solution is expected on real-time;

8. Road-Network DRSP: same as category 7 adding the consideration of the road network layout. This is not trivial as solutions pre-compute the distance matrix for each stop, and if the supply and demand dynamic changes, pre-computing the distance matrix is not a viable solution;

9. Multimodal DRSP: same as category 8 adding the use of other transportation modes before and after a ride-share, such as walking, bicycle, public transport, car, taxi, among others;

10. City sized multimodal DRSP: same as category 9 adding the consideration of hundreds of thousands of passengers in thousands of vehicles.

Efficiently solving category 10 also means solving category 1-9. As such, this is exactly the problem that is addressed by this disclosure, and the exemplary embodiments described herein.

### Dynamic Ride-Sharing Problem

Initially, define a city-sized multimodal dynamic ride sharing matching problem as a constrained optimization problem. The intuition behind this approach is quite simple, starting from the assumption that travelers in a city don't like to lose time, or money, or both—especially for their daily commuting activities. As such, the problem is modeled to find the best matches between drivers and passengers as a problem of finding a solution where the total loss of time, for all drivers and passengers in a city, is minimal.

Notably, the choice to use the loss of time here is just an example. Alternatively, other loss functions such as, but not restricted to, total amount of money spent in traveling, total distance traveled, a combination of losses, etc.

In order to get from a departure point A to a destination point B, a passenger needs to follow a journey which passes through multiple waypoints. A journey is defined as a sequence s of tridimensional points (latitude, longitude, time) defined in space and time that a passenger can follow in order to reach B from A. Each element sᵢ of a trip s will henceforth be referenced as a waypoint. Each waypoint is defined as a stopping point in a journey. The set of all possible journeys a passenger can make will be denoted Sₚ.

From the viewpoint of the passenger, each change from waypoint sᵢ to the next waypoint sᵢ₊₁ has an associated cost c(sᵢ, sᵢ₊₁). For example, this means the time spent to go from one point to the other. For a passenger p, the loss associated with travelling through s can be stated as

Cₚ(s)=Σₗ₌₀ⁿ⁻¹ cₚ(sᵢ, sᵢ₊₁). (Eq. 3)

Notably, the passenger's costs on moving between stops can also reflect more factors. For instance, besides the time factor, a passenger may assign a fixed penalization term associated with each stop, which would indicate that trips with less stops would be preferred, such as by taking

cₚ(sᵢ, sⱼ)=c(sᵢ, sⱼ)=βₚ (Eq. 4)

Furthermore, the losses associated with each potential car-sharing driver d must be considered. For each driver, most of same rules regarding the journey apply. However, the key difference lies in the fact that now, at each waypoint sᵢ of the driver's journey, a passenger can be picked-up by the driver and share the ride to some waypoints sⱼ where j>i. Also considered is the an extra cost δⱼ associated with picking up each passenger at waypoint j, and as well a reward term Rⱼ that motivates the driver to pick-up this passenger in the first place. This gives the expression

C_{d}(s)=Σⱼ₌₀^{k-1} c_{d}(sᵢ, sᵢ₊₁)+Σⱼ₌₀^{k} λⱼ(δⱼ−Rⱼ+γ_{d}), (Eq. 5)

in which λⱼ is the number of passengers to be picked-up at stop j, and γ_{d} is a driver specific penalization term associated with picking passengers during the trip. The driver-specific waypoint moving cost function c_{d}(sᵢ, sⱼ) can analogously incorporate a fixed penalization term associated with each stop, giving the expression

c_{d}(sᵢ, sⱼ)=c(sᵢ, sⱼ)+α_{d} (Eq. 6)

Finally, the optimization problem is defined as a problem of minimizing the overall city loss. The overall city loss can be defined as the combined loss of all travelers in the city, whether they are passengers or car drivers.

For purposes of the following discussion, D is denoted as the set of all drivers in the city, P is denoted as the set of all passengers, and T=D ∪ P is denoted as the set of all travelers in the city. For each traveler in the city, denoted by journey assignment is a tuple of the form w=(t, s) specifying that a traveler t ∈ T took a journey s. Also, the set of assignments made for all travelers in the city is denoted as ω, such that for any traveler t ∈ T there exists a w ∈ ω associating a journey to this traveler. Lastly, the set of all of such possible assignments is denoted as Ω, such that ω ∈ Ω.

Given a traveler assignment vector ω, the loss associated with each passenger journey assignment can then be written

Lₚ(ω)=Σ_{(t,s)∈ω} 1_{t∈P} Cₚ(s) (Eq. 7)

where 1_{t∈P} is a function that returns 1 if the traveler is a passenger, and zero otherwise. Likewise, the loss associated with each driver journey assignment can be written

L_{d}(ω)=Σ_{(t,s)∈ω} 1_{t∈D} C_{d}(s) (Eq. 8)

where 1_{t∈D} is a function that returns 1 if the traveler is a driver, and zero otherwise. The task of minimizing the overall city loss can then be expressed as the problem of finding the best journey assignments

min_{ω∈Ω} Q(Lₚ(ω), L_{d}(ω)) (Eq. 9)

such that,

$$\begin{matrix}\text{∀} 〈 t , s 〉 ∈ ω , & feasible\_departure ( {s}_{0} , t ) ; \\ \text{∀} 〈 t , s 〉 ∈ ω , & feasible\_arrival ( {s}_{\vert s \vert - 1} , t ) ; \\ \text{∀} 〈 t , s 〉 ∈ ω : t ∈ D & \text{∀} {s}_{i} ∈ s , {\sum }_{j = 0}^{i} {λ}_{j} - {μ}_{j} \leq capacity ( d ) ; and \\ \text{∀} 〈 t , s 〉 ∈ ω & \vert s \vert < {max}_{stops ( t )} ,\end{matrix}$$

where Q is any user-defined way of combining the separate losses for passengers and drivers, respectively. Moreover, λⱼ is the number of passengers to be picked-up at the jth stop of a driver's journey, μⱼ is the number of passengers to be dropped-off at the jth stop of a driver's journey.

The functions feasible_departure(s, t) and feasible_arrival(s, t) return, respectively, whether the tridimensional points (latitude,longitude,time) for the beginning and ending of a journey are sufficiently close to the traveler's announced destinations within some tolerance threshold. The function capacity(d) returns the announced vehicle capacity for driver d. Function max_stops(t) returns the maximum number of stops a traveler t is willing to make during a journey.

### Public Transport Networks and the Trip Planning Problem

Public transport covers a set of transportation services and options provided within a city or other urban administrative divisions. Transport networks encompass the different routes and schedules that are followed by one or more types of transportation vehicles. Common vehicle types, or transport modes, found in typical networks include buses, trains, trams and subways. Routes are groups of vehicle trips that follow predefined schedules in a recurrent manner.

Typical networks are designed to offer accessibility with the least changes of vehicles in the least amount of time. Constructed to answer transportation needs for the inhabitants of a region, the way a network spreads its services across a city also tends to change the city itself, providing an important factor for real estate decisions as well as services distributed across the region.

In order to effectively use a public transport network, travelers or any other users of the network can use transportation tools known as trip planners. Public transport trip planners are optimization engines capable of finding the best path to go from one geodesic point to the other. Depending on travelers' preferences, the best path can be different. For example, the path can be the shortest; the path that arrives sooner, or with the least number of transfers. An ideal trip planner will find a personalized journey by searching the best path over all the traveler's objectives. Some trip planners are more sophisticated than others and will give more diverse options to reach a destination. Multimodal trip planners search paths on combined modes of transportation and are capable to dynamically integrate real time schedule and network changes.

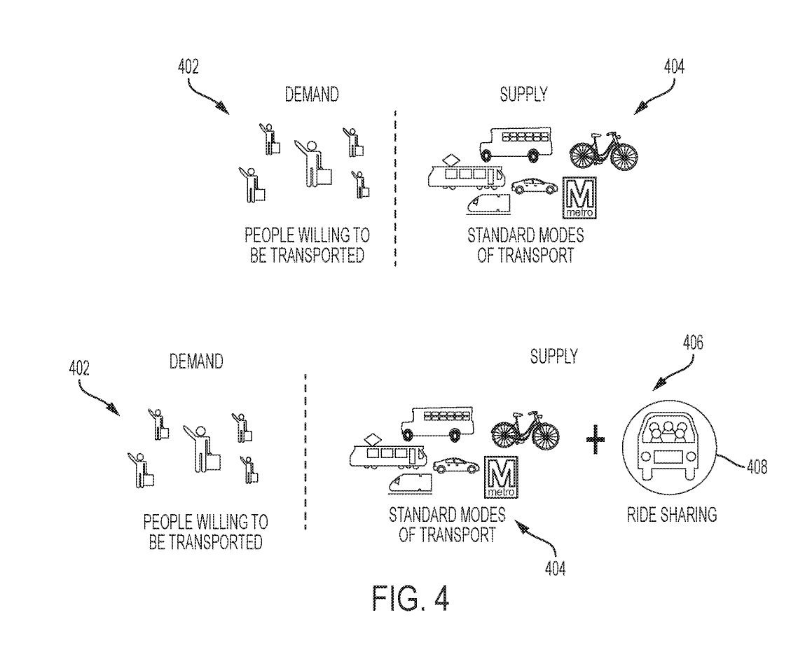

In a standard public transport application, the demand and the supply are modeled taking into consideration the flux of travelers within a city and their options to fulfill their travel needs. One way to model and understand demand is through origin-destination estimation. This method is further described in U.S. Pat. No. 8,977,496, issued Mar. 10, 2015, by Ulloa Paredes et al., entitled “SYSTEM AND METHOD FOR ESTIMATING ORIGINS AND DESTINATIONS FROM IDENTIFIED END-POINT TIME-LOCATION STAMPS”, where it can be used by transport authorities to better understand their targeted public needs and adjust the network supply as needed. FIG. 4 illustrates how demand and supply can be understood in most public transport network applications, where the top figure is the standard view of demand 402 and supply 404 for public transport models, and the bottom figure is the extended public transport view including ride-sharing 408 as part of the supply 406.

An important aspect of the disclosed method and system is the ability to incorporate ride-sharing offers as part of a public transport network supply offerings. Given the dynamic nature of the ride sharing problem, where users make offers or register for rides in time windows of less than 15 minutes, this would be a difficult task to be performed in a trip planner that needs the public transport schedules to be available and processed ahead-of-the-time. U.S. patent application Ser. No. 14/450,628, filed Aug. 4, 2014, by Ulloa Paredes, entitled “EFFICIENT ROUTE PLANNING IN PUBLIC TRANSPORTATION NETWORKS”, provides a route planning framework that does not require preprocessing public transportation.

### From Car-Sharing to Virtual Vehicles

This section describes how to map drivers' offerings to share a ride with public transport vehicles such as buses. In order to be registered for a public transport network, a vehicle must be entitled to a schedule. A schedule includes a set of locations and times where a vehicle must pass in order to gather or deliver passengers. In the car-sharing scenario, the car is viewed as a transportation vehicle with a flexible schedule where only two points are roughly defined: the departure local and the desired departure date; and the arrival can and the desired arrival date.

Notably, while these points might be fully determined, the driver might allow for some flexibility for the intended points when making their offer, such as allowing for departing 15 minutes before or after in case this would help find more passengers for their ride. Furthermore, the driver may also specify vicinity points or neighborhoods to be either preferred or avoided during a trip. All things considered, all of this information can be used to build, for each driver, a set of virtual schedules this driver can offer.

Next, clear indications of likely places a driver would go pick up passengers is determined. Demand estimation can be used to identify the most likely points in a city where passengers might gather around when they wish to travel. One way to perform this task is to use a non-supervised clustering algorithm to cluster origin-destination pairs, obtaining geospatial centroids spread across the city that can then be used as waypoints for a driver to pass.

Once waypoints have been determined, the method generates several distinct virtual schedules considering all possible waypoints a driver might pass. The schedule generation algorithm includes a streaming process. Schedules are generated on-request by taking waypoints according to their popularity (centroid strength, measured in how many origin-destination pairs are covered by a given centroid) and the driver's preferences, such as how far the driver is willing to deviate from the route, which neighborhoods would be more likely to be visited or avoided. The method then generates a preconfigured number of virtual schedules for each driver and stores them in the virtual transport network collection of schedules.

Finally, these schedules are then communicated to the trip planner at each future request by a traveler to generate routes from one point to another. Because the trip planner is configured to support these scenarios, even if the virtual schedules are generated on-demand, this has only a minimum effect on the planner's response times. In other words, future calls to the trip planner service will enlist potential car-sharing drivers that are going on the same route as a user that is inquiring to the trip planner to aid on his or her trip. If a user would like to go from the workplace to the town center, for example, the trip planner would also include, potentially several, alternative journeys taking into account not only public transport offerings but also independent drivers who announced their routes previously to the system.

### Matching Drivers and Passengers

Described hereto is how passengers can inquire the system to get a list of potential drivers they can contact in order to share a ride to their destination. However, providing this service, albeit useful, is still incomplete: it leaves up to the user the task of calling the driver and checking if there are still any places available in the car to share a ride, in the first place.

As such, now provided are mechanisms to achieve both local and global optimization solutions that can find the best time-saving options or any other metric, such as money-saving or smallest travel distance, for all users in the network. For all strategies provided here, the main characteristic to observe is that the system described is able to provide a list of most suitable journey options for each passenger querying the system. In each of those journeys, different drivers may be available that are passing through the same departure and destination locations as the user. As such, obtainable for each user is a constrained list of potential drivers they can contract during their journey. This list can represent only a tiny fraction of all possible drivers in the system, and as such, shrinks the matching problem to much more manageable dimensions.

Given a service that can register drivers' announcements and passenger requests, the following solutions are provided for the user matching problem. Notably, the following algorithms need to be re-run or partially re-run either on a timely basis or triggered whenever a sufficient number of new announcements are registered in the system. The algorithms, however, don't have to discard all previously computed results, and as such, can be run to completion into a suitable amount of time.

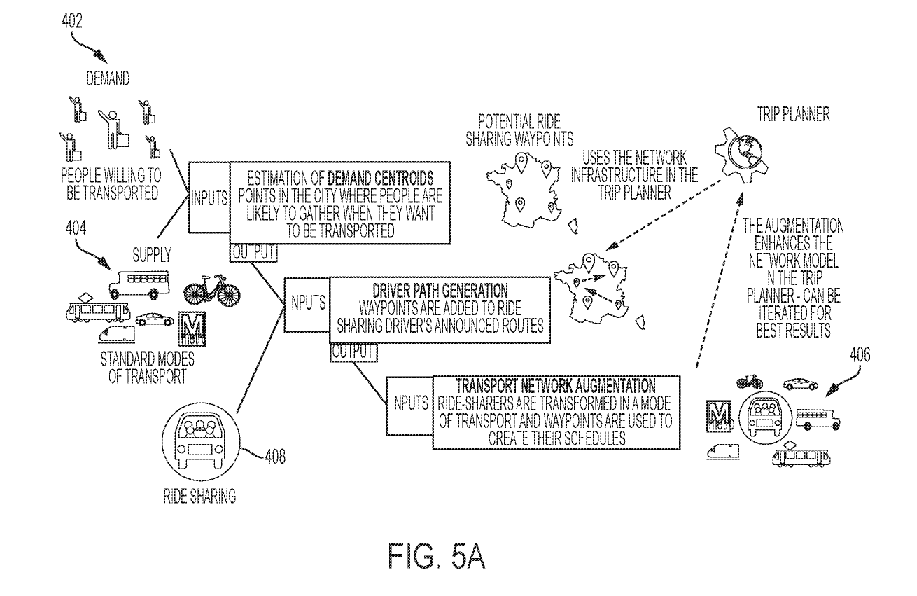

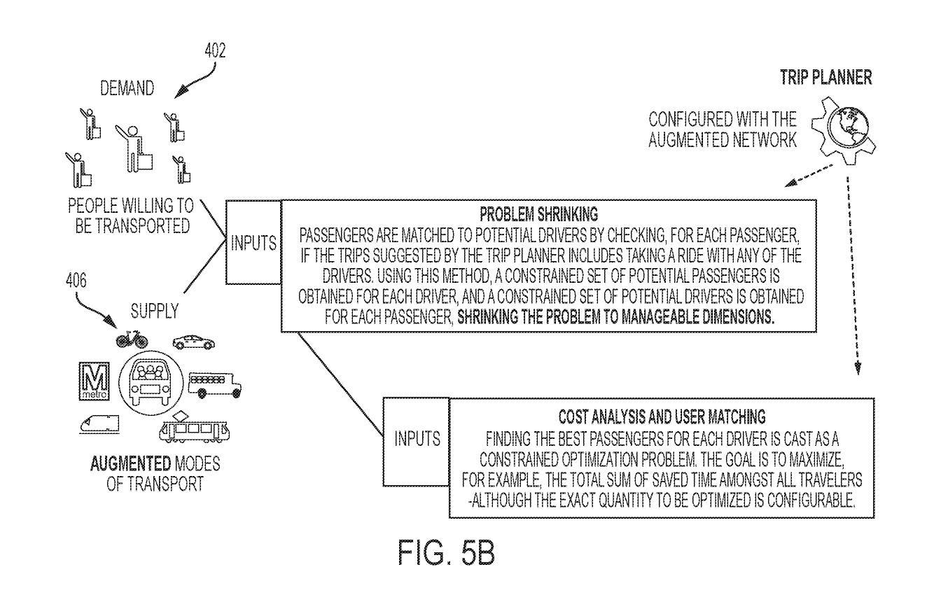

As previously described, FIG. 5A is an infographic illustrating the generation of an augmented public transportation network according to an exemplary embodiment of this disclosure, and FIG. 5B is an infographic illustrating the use of the augmented public transport network generated in FIG. 5A to provide a solution to a user matching problem associated with a dynamic multimodal ride-sharing according to an exemplary embodiment of this disclosure.

### Matching Algorithms

Below, provided are three different naïve algorithms and one efficient algorithm to perform user-matching in the constrained sets given by our trip planner. In the first naïve algorithm, the Trip Planner returns only one trip per passenger willing to take a ride, where the system is attempting to make as many people as possible use ride sharing if ride sharing helps them save more time during their trips.

For each new passenger that would like to use the ride-sharing service, the system asks the trip planning service to give the fastest route this user can use to get from their departure place and time and arrive at their destination and intended arrival time. Then, it checks for each driver on the suggested route to determine if their cars can still take new passengers. If they can't, then the user is assigned to that car. If not, the system asks again the trip planner for alternative routes that include only public transport.

Algorithm. Best-effort matching.

```
for each user in users
  let journey ← get_fastest_journey(user)
  for each driver in journey
```

```
if free_passenger_seats(driver) > 1 then
  assign(user, driver)
  end-if
```

end-foreach
end-foreach

An alternate version of the algorithm above is to use the trip planner's alternative route suggestion feature to generate several alternative routes that may consider different drivers for each route.

Algorithm. Constrained search matching.

```
for each user in users
  let journeys ← get_alternative_journeys(user, alternatives: 5)
  sort journeys by duration
  for each journey in journeys
```

for each driver in journey
if free_passenger_seats(driver) > 1 then

assign(user, driver)
break

end-if
end-foreach

end-foreach
end-foreach

The final naïve version considered here attempts to find journey matches that are in the best interest of all passengers at the same time. For each potential passenger, registered are a limited set of possible alternative journeys that may or may not include any drivers during the trip. Then, for each journey and for each driver in those journeys, registered are the user-driver pair alongside how much time (or any other metric) it would take to travel during this journey. Finally, this list is sorted by the selected metric, and passengers are assigned to drivers in the sorted order.

Algorithm. Greedy multiple matching.
let passengers be a set of users that have already been assigned to any car
let pairs be a set of triplets containing a user, a driver, and trip duration

```
for each user in users
  let journeys ← get_ alternative_journeys(user, alternatives: 5)
  for each journey in journeys
```

for each driver in journey
pairs ← pairs ∪ { <user, driver, duration(journey)> }
end-foreach

```
  end-foreach
end-foreach
sort pairs by duration
for each pair in pairs
  let user ← user in pair
  let driver ← driver in pair
  if user is not in passengers then
```

if free_passenger_seats(driver) > 1 then

assign(user, driver)
passengers ← passengers ∪ { user }

end-if

end-if
end-foreach

The last algorithm provided provides an efficient, polynomial time solution for the user-matching problem. The solution is based on the Munkres' assignment algorithm with rectangular matrix modifications. See MUNKRES, “ALGORITHMS FOR THE ASSIGNMENT AND TRANSPORTATION PROBLEMS”, Journal of the Society for Industrial and Applied Mathematics; Vol. 5, No. 1, March, 1957, pages 31-38. This algorithm is known to solve assignment problems including finding a maximum weight matching in a weighted bipartite graph in polynomial time.

Using this algorithm, specified is an augmented rectangular cost matrix formed by appending each distinct cost matrix for a single vehicle and their possible passengers together, as exemplified in the table below.

| | | | | | | Vehicle n | | |
|---|---|---|---|---|---|---|---|---|
| | | | | | | | | Capac- |
| Vehicle 1 | | Vehicle 2 | | | | | | ity of |
| Seat | Seat | Seat | Seat | Seat | . . . | Seat | | vehicle |
| 1 | 2 | 1 | 2 | 3 | . . . | 1 | . . . | n. |

| | | | | | |
|---|---|---|---|---|---|
| Passenger | cost | cost | cost | cost | cost |
| 1 | | | | | |
| Passenger | cost | cost | cost | cost | cost |
| 2 | | | | | |
| Passenger | cost | cost | cost | cost | cost |
| 3 | | | | | |
| . . . | | | | | |
| Passenger | | | | | |
| m | | | | | |

This assignment algorithm is further described in BOURGEOIS et al., “AN EXTENSION OF THE MUNKRES ALGORITHM FOR THE ASSIGNMENT PROBLEM TO RECTANGULAR MATRICES”, Communications of the ACM, December, 1971, Volume 14, Number 12, pages 802-804.

### Integrating Virtual Schedules and Matching Algorithms

The driver's schedule generation and the subsequent passenger and driver matching is done in a sequential fashion. This sequential nature of the schedule generation process leads to two different approaches for processing matches: in-order, in which the next step depends on the result of the previous one and thus the processing must be done sequentially; or in-parallel, in which some of the steps are considered independent and can be processed by a distinct computing device over a network.

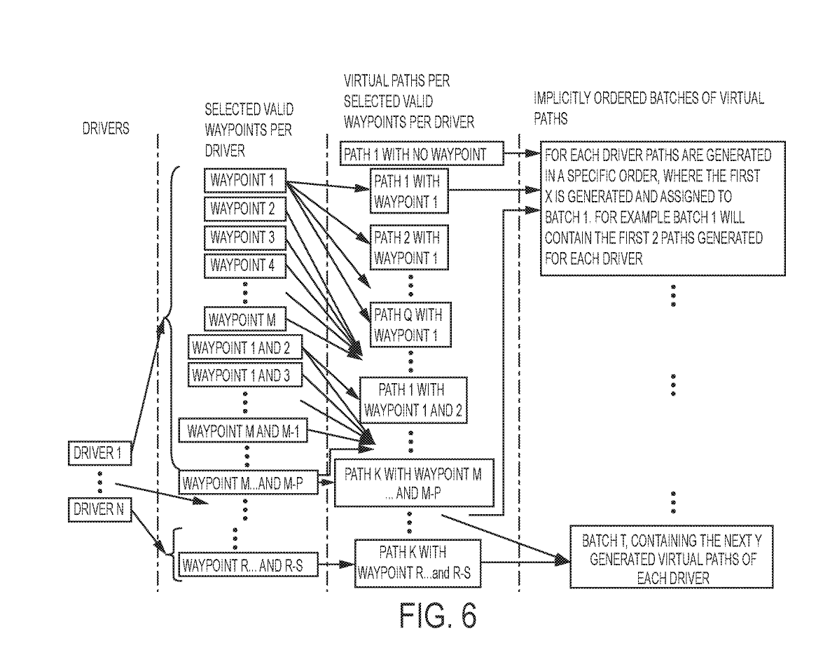

The diagram in FIG. 6 illustrates the number of possible virtual paths that can be generated (all letter variables are independent to other diagrams or this document). For all drivers there is a set of valid waypoints, based on the constraints and preferences. Each combination of such waypoints can produce a set of virtual paths. For each driver we generate one by one the virtual paths in a specific order. We can then sequentially create batches that contain some of the paths of each driver without generating all possible paths. These batches are used in both approaches to generate matches without having to consider all paths, only keeping the best matches.

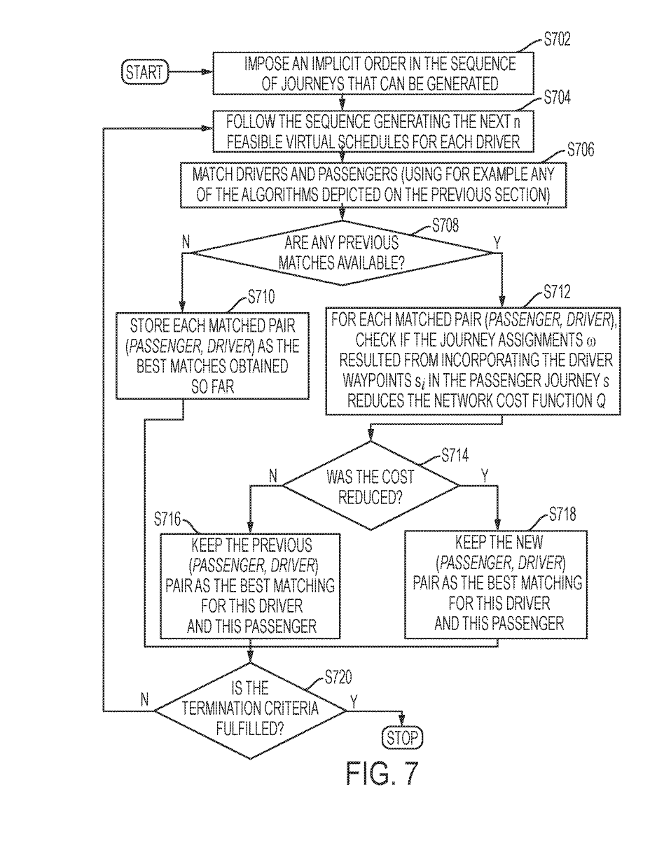

The diagram in FIG. 7 illustrates a sequential process where each step generates new schedules which are used to improve over the current solution.

Initially, at step S702, the process imposes an implicit order in the sequence of journeys that can be generated. This order will determine the order in which paths are assigned to batches.

Next, at step S704, the process follows the sequence generating the next n feasible virtual schedules for each driver. That is, generating the next batch of paths to be processed.

Next, at step S706, the process matches drivers and passengers (using for example any of the algorithms depicted on the previous section).

Next, at step S708, the process determines if any previous matches are available.

If previous matches are not available, then the process stores each matched pair (passenger, driver) as the best matches obtained so far S710 and executes block S720 to determine if the process termination criteria is fulfilled. If the termination criteria is fulfilled, the process stops. If the termination criteria is not fulfilled, the process returns to step S704 to follow the sequences generating a second next n feasible virtual schedules for each driver.

If, at step S708, the process determines previous matches are available, the process executes step S712, where for each matched pair (passenger, driver), check if the journey assignments ω resulted from incorporating the driver waypoints Sᵢ in the passenger journeys s reduces the network cost function Q.

Next, at step S714, the process determines if the cost was reduced. If the cost was reduced, the process executes step S718 to keep the new (passenger, driver) pair as the best matching for this driver and this passenger. If the cost was not reduced, the process executes step S716 to keep the previous (passenger, driver) pair as the best matching for this driver and this passenger.

After the appropriate pair is stored, the process executes block S720 to determine if the process termination criteria is fulfilled. If the termination criteria is fulfilled, the process stops. If the termination criteria is not fulfilled, the process returns to step S704 to follow the sequences generating a second next n feasible virtual schedules for each driver.

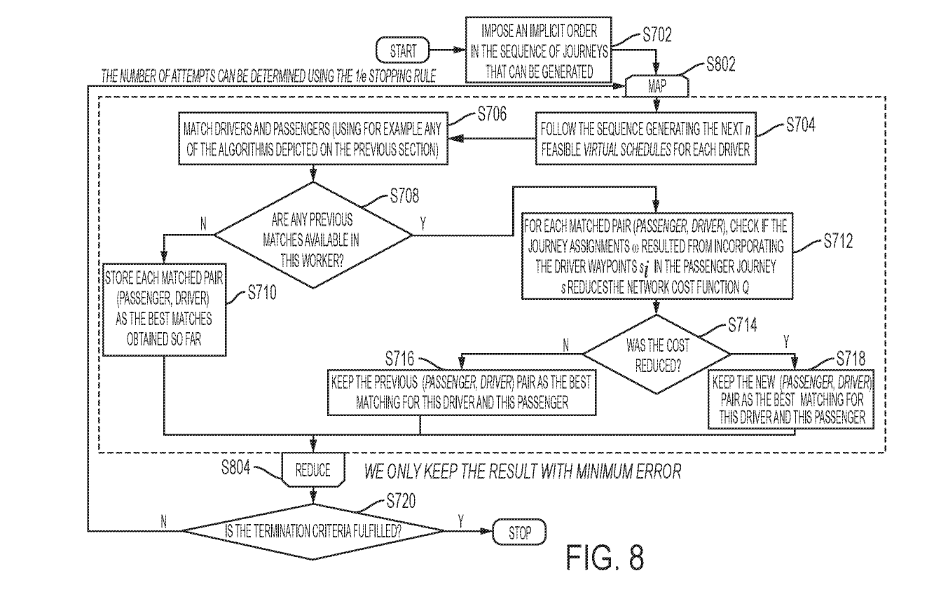

The diagram in FIG. 8 illustrates a parallel process, where each concurrent step generates new schedules which are generated and are then used to compute new solutions. Those new solutions are then compared against the others in order to keep only the best solution found so far.

In addition to performing steps S702, S704, S706, S708, S710, S712, S714, S716, S718 and S720, as described for the sequential process illustrated in FIG. 6, the parallel process performs step S802 to map the ordered sequence of journey generated in step S702 prior to executing step S704. The step S802 assigns a different batch to each worker, the batches having different paths will make each worker have different possible matches.

In addition, step S804 is performed to reduce the passenger/driver pairs, where only the pairs with a minimum error are retained.

In both cases, the sequential process and the parallel process, letting the processes iterate over all possible elements in the schedule generation sequence is akin to exhaustively enumerating all hypothesized solutions of the optimization problem domain. As such, this method generates a non-decreasing sequence of better solutions at each step, approaching optimality in a finite, but potentially extremely large, number of steps.

As such, the strategy presented here is to allow for a certain quantity of steps according to optimal stopping theory. See FERGUSON, “WHO SOLVED THE SECRETARY PROBLEM?”, Statistical Science, Vol. 4, No. 3, August, 1989, pages 282-289. In the next section, the matching algorithms described above are used together with the in-order processing scheme considering only a single iteration step to report the results of our transformation technique in the context of a medium-sized city, to demonstrate how solutions can be found by checking only a fraction of the solution space.

### Results

Provided below are results of an implementation of the dynamic car-sharing method and system disclosed under some experimental conditions. These experiments were performed on real data gathered from the city of Nancy, France.

Nancy is a city in north-eastern France with about 410,509 habitants living within its metropolitan area. With a large public transport network comprised of trams, buses and trains, the urban community of Greater Nancy utilizes services to monitor and administer their existing transportation infrastructure.

The Nancy region registers around 100,000 ticket validations per day in an average business week. Alongside this data, full information is available regarding the physical disposition of its road network and as well as their public transport schedules for trams, trains and buses.

For this region, obtained were estimated origin-destination for public transport passengers using the method detailed in U.S. Pat. No. 8,977,496, issued Mar. 10, 2015, by Ulloa Paredes et al., entitled “SYSTEM AND METHOD FOR ESTIMATING ORIGINS AND DESTINATIONS FROM IDENTIFIED END-POINT TIME-LOCATION STAMPS. This is the same method employed by the ATLAS® Data Mining tool in use by the city operators. In order to estimate the impact the dynamic car-sharing system would inflict upon the region's transportation needs, a proportion of the public transport users were sampled to act as car-sharing drivers. This is akin to convincing some of the public transport users to use their car to travel to their destination instead of using the public transport network. Since the origin-destination estimation takes into accounts the fully reconstructed trips those users took, this is the equivalent of those users taking their car to go directly from their home to their workplace, for example, surpassing any additional intermediary steps they originally had to do to switch between trams or buses.

Furthermore, the trip planner is configured to accept all public transportation modes, plus walking.

During the experiments, measured are the cost of each journey as the time taken by each agent to fulfill their journey. The reward factor for the drivers is considered taken as a proportion of the total time savings they can provide for each potential passenger. In a real world system, this abstract reward value given to each car-sharer could be either converted directly to money, or could also be part of a point system such as frequent-flyer programs, loyalty and fidelity programs, and so on. However, those specificities are not strictly necessary to evaluate the effectiveness of the disclosed method and system, but instead illustrate the potential market ramifications of this system.

In order to model how users make their decisions, the way users interact with a dynamic car-sharing system are modeled by agent state transitions. For instance, agents can switch from waiting for a match, to match accepted and match rejected. Further considered are that these can be either voluntary or not: they could be consequences of travelers, drivers or public transport being early or late, or event accidents blocking the roads. Therefore, at every moment, taken into account are that the best matching solution can change. The experiments then consider the system only at a particular moment when the number of participating agents is close to maximum and thus more stable to be measured and analyzed.

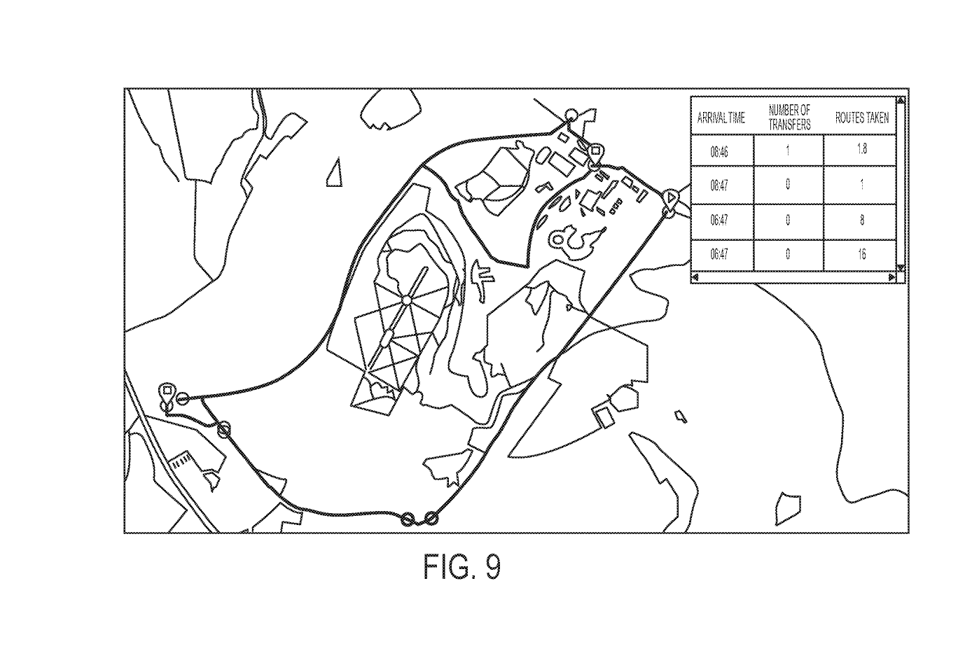

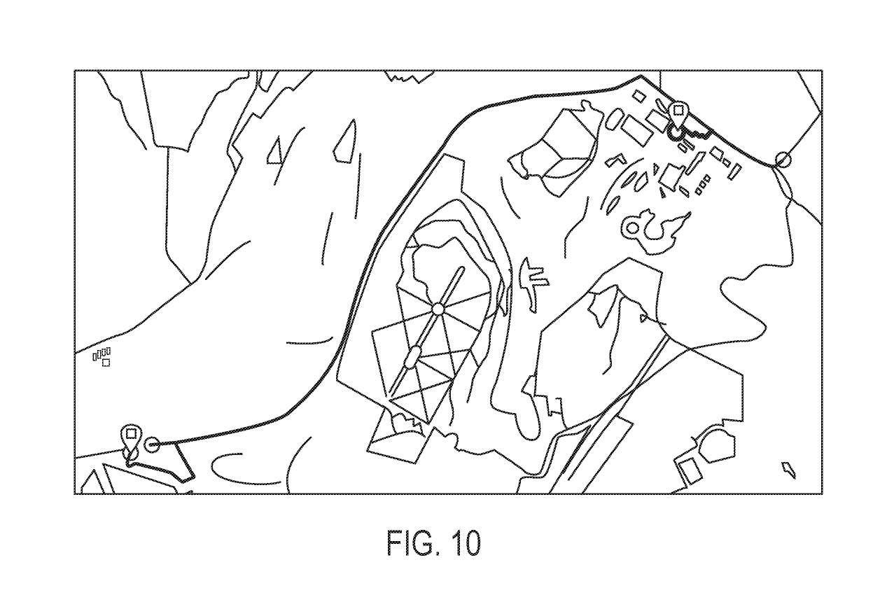

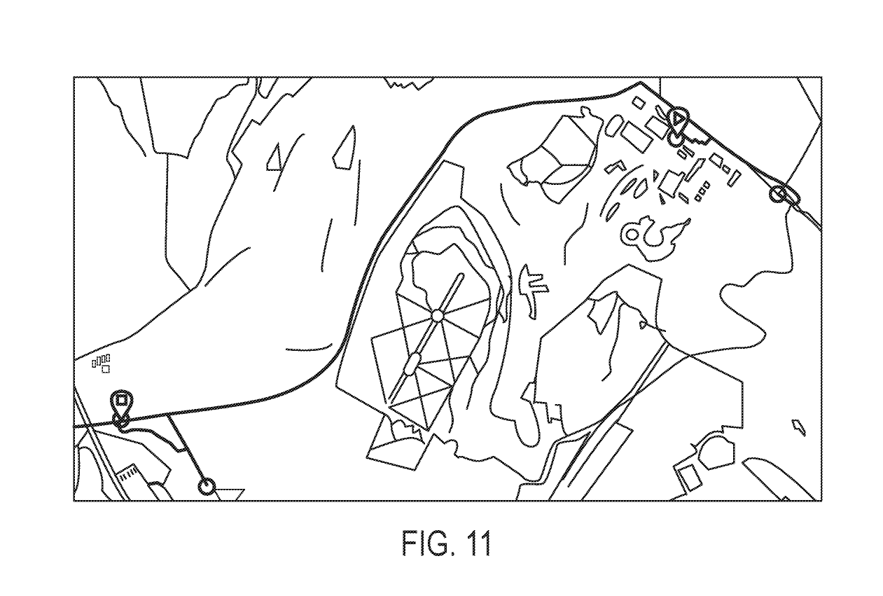

FIGS. 9-15 display graphical results for the estimated scenarios. Alternative routes considering ride sharing are shown in FIG. 9 through FIG. 11. The incorporation of car-sharing among the suggested transport modes both decrease average travel times but as well increased the reachability of some regions not directly served by the public transport network.

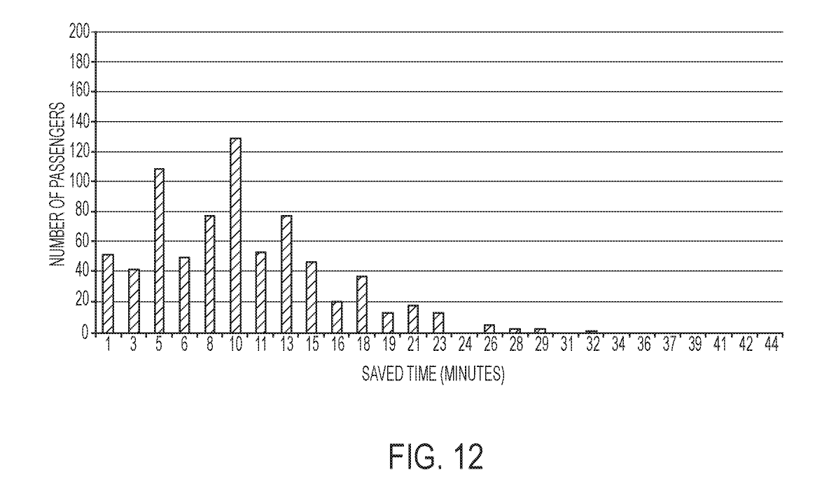

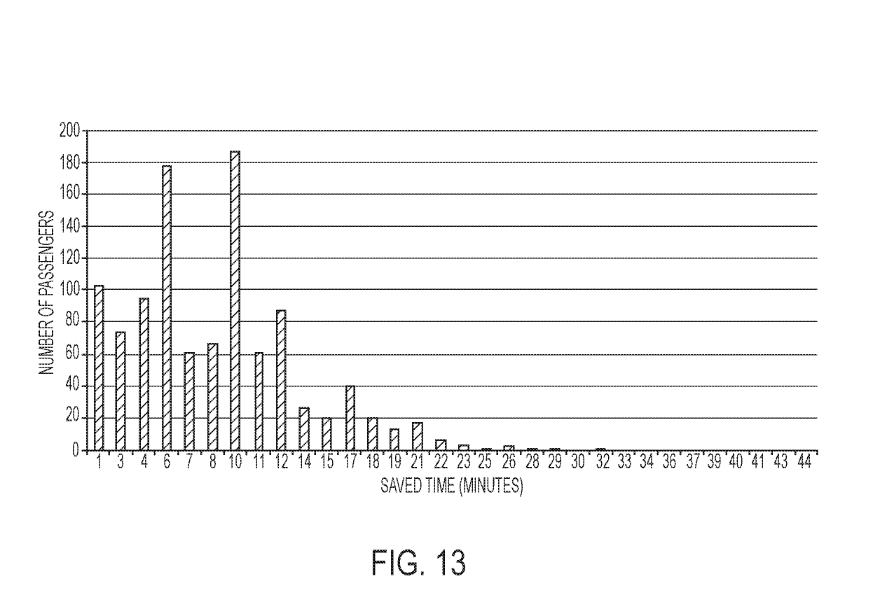

Moreover, the amount of time saved per passenger is analyzed considering the different algorithms enumerated in the previous section. For instance, FIG. 12 illustrates the time-savings distributions when considering the first proposed algorithm. FIG. 13 shows results for the third proposed algorithm. Notably, even if time savings are centered at around 10 minutes, most of the trips performed within a city last less than 20 minutes overall. In this case, it means the disclosed method and system have been able to improve up to 50% transportation times in contrast to traditional forms of transportation. Further attention should also be given to the distribution tails on those graphs: users who travel the longest distances on a given day—and thus need it the most—are also the ones who are really benefiting from this solution.

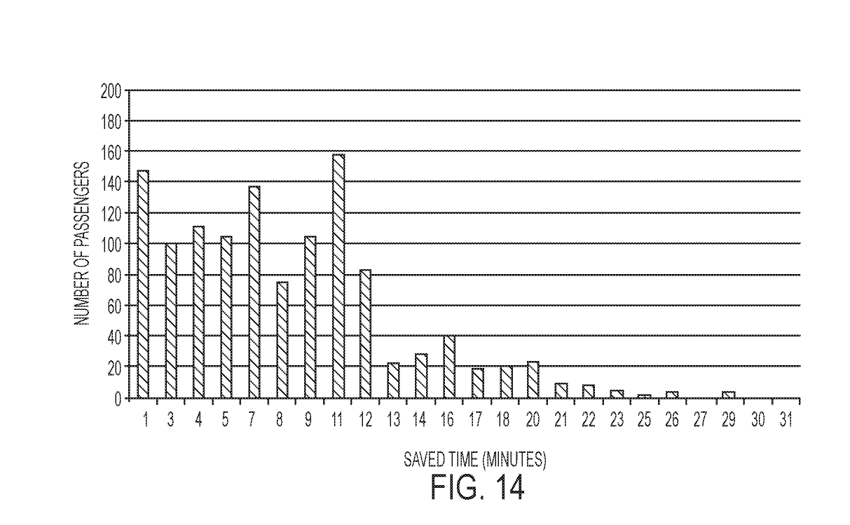

The system described here also allows for further analysis cases. For instance, explored is the case in which each driver, instead of having an average car, has an 8-seat car such as a family wagon or family sedan. Hypothesized are those car types would include a significant amount of the car-sharing dynamic fleet, since those cars would be especially suited to be used by drivers who would like to make profitable trips, as shown in FIG. 14.

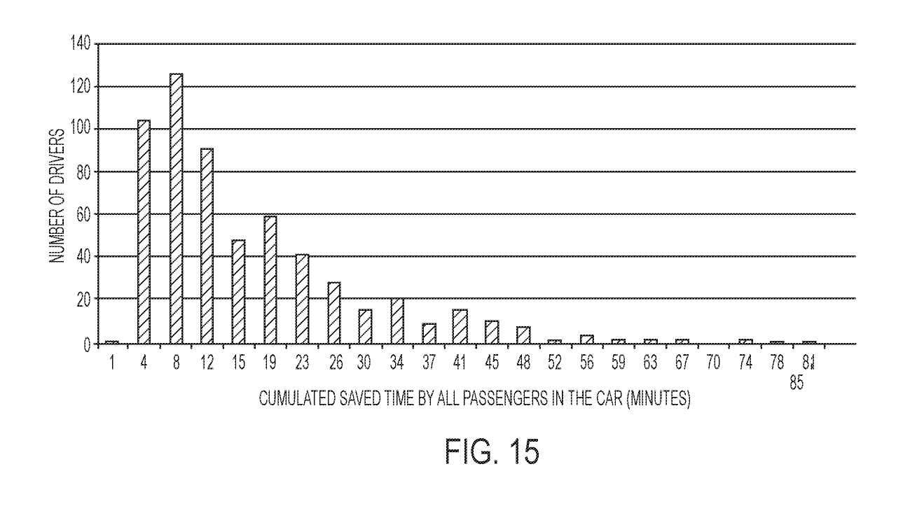

Furthermore, analyzed is how much saved time drivers contribute to the network. In this setting, not only are drivers are able to replace traditional transportation modes such as buses, but also provide significant time savings to the traveler community. For example, FIG. 15 shows that more than 90 drivers were able to contribute with more than half an hour of cumulated time savings among the passengers they took.

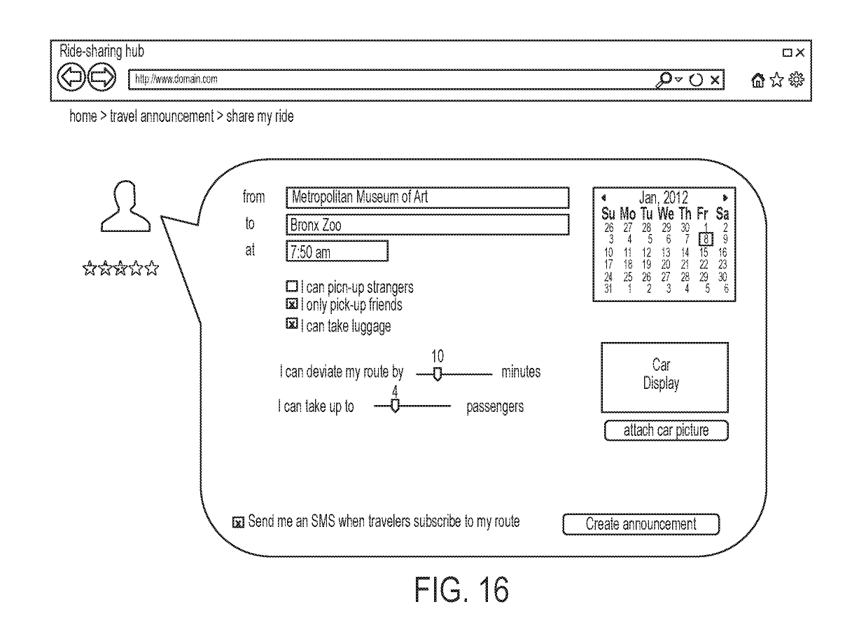

With reference to FIG. 16, illustrated is an example of a driver interface to announce ride-share information to a trip planning system according to an exemplary embodiment of this disclosure.

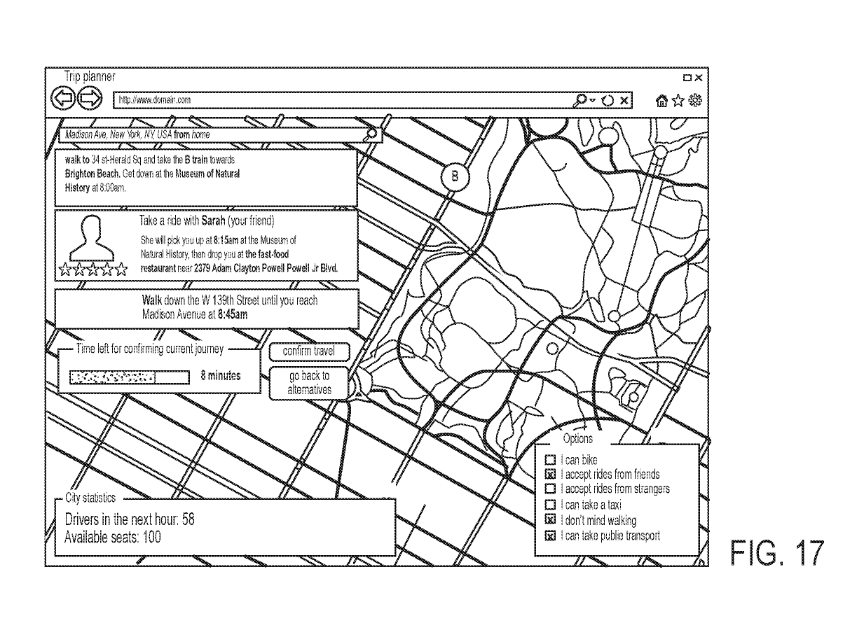

With reference to FIG. 17, illustrated is an example of a potential rider interface which generates an available path including a ride-share route, as announced by a driver in FIG. 16, according to an exemplary embodiment of this disclosure.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for generating one or more available paths from a rider origin location to a rider destination location using a trip planning platform, the available paths including, at least in part, a ride-sharing route and the trip planning platform configured to generate one or more paths associated with a transportation network including one or more fixed routes of transportation associated with one or more of buses, trains, bikes, walking paths and trams, the method comprising:
a) receiving, by a processing device, ride-share information from a driver offering to ride-share, the ride-share information including a driver desired departure location and time/date, and a driver desired arrival location and time/date;
b) mapping, by the processing device, the ride-share information to virtual vehicle routes within the transportation network including one or more ride-share fixed routes, each of the ride-share fixed routes associated with the driver desired departure location and driver desired departure time/date, and the driver desired arrival location and driver desired arrival date/time;
c) receiving, by the processing device, a request from a potential rider to determine one or more available paths between a rider origin location and a rider destination location desired by the potential rider within the transportation network; and
d) generating, by the processing device, the one or more available paths within the transportation network, the one or more available paths including one or more of the virtual vehicle routes and the one or more available paths associated with available paths that are calculated to have a minimal cost, the cost associated with one of arrival time of the potential rider at the rider destination location, duration of travel of the potential rider to the rider destination location, number of routes associated with travel of the potential rider to the rider destination location, distance of travel of the potential rider to the rider destination location, and monetary cost of travel of the potential rider to the rider destination location.

2. The method for generating one or more available paths according to claim 1, wherein the method includes generating one or more potential meeting locations for the one or more potential meeting locations for the one or more drivers and the potential rider, the meeting locations provided by demand centroids based on origin-destination historical data.

3. A computer program product comprising a non-transitory recording medium storing instructions for performing the method of claim 1, and a processor in communication with the memory which implements the instructions.

4. A system comprising memory storing instructions for performing the method of claim 1, and a processor in communication with the memory which implements the instructions.

5. A ride-sharing path generation system comprising:
a trip planning platform configured to generate one or more paths associated with a transportation network including one or more fixed routes of transportation associated with one or more of buses, trains, bikes, walking paths and trams;
a driver ride-share information receiving component configured to receive ride-share information from one or more drivers offering to ride-share, the ride-share information including a driver desired departure location and time/date, and a driver desired arrival location and time/date;
a virtual vehicle mapping component configured to map the ride-share information to virtual vehicle routes within the transportation network including one or more ride-share fixed routes, each of the ride-share fixed routes associated with the driver desired departure location and driver desired departure time/date, and the driver desired arrival location and driver desired arrival date/time;
a rider request component configured to receive a request from a potential rider to determine one or more available paths between a rider origin location and a rider destination location desired by the potential rider within the transportation network; and
a path generation component configured to generate the one or more available paths within the transportation network, the one or more available paths including one or more of the virtual vehicle routes and the one or more available paths associated with available paths that are calculated to have a minimal cost, the cost associated with one of arrival time of the potential rider at the rider destination location, duration of travel of the potential rider to the rider destination location, number of routes associated with travel of the potential rider to the rider destination location, distance of travel of the potential rider to the rider destination location, and monetary cost of travel of the potential rider to the rider destination location.

6. A method for generating one or more available paths from a plurality of rider origin locations to a plurality of respective rider destination location using a trip planning platform, the available paths including, at least in part, a ride-sharing route and the trip planning platform configured to generate one or more paths associated with a transportation network including one or more fixed routes of transportation associated with one or more of buses, trains, bikes, walking paths and trams, the method comprising:
a) receiving, by a processing device, ride-share information from a plurality of drivers offering to ride-share, the ride-share information including, for each driver, a driver desired departure location and time/date, and a driver desired arrival location and time/date;
b) mapping, by the processing device, the ride-share information to virtual vehicle routes within the transportation network including one or more ride-share fixed routes, each of the ride-share fixed routes associated with a respective driver desired departure location and driver desired departure time/date, and the driver respective desired arrival location and driver desired arrival date/time;
c) receiving, by the processing device, a request from a plurality of potential riders to determine one or more available paths between a rider origin location and a rider destination location desired by each of the respective potential riders within the transportation network; and
d) generating, by the processing device, the one or more available paths within the transportation network, the one or more available paths including one or more of the virtual vehicle routes and the one or more available paths associated with available paths that are calculated to have a minimal cost, the cost associated with one of arrival time of the potential rider at the rider destination location, duration of travel of the potential rider to the rider destination location, number of routes associated with travel of the potential rider to the rider destination location, distance of travel of the potential rider to the rider destination location, and monetary cost of travel of the potential rider to the rider destination location.

7. The method for generating one or more available paths according to claim 6, wherein the method includes generating one or more potential meeting locations for the one or more of the plurality of drivers and one or more respective potential riders, the meeting locations provided by demand centroids based on origin-destination historical data.

8. The method for generating one or more available paths according to claim 6, further comprising:
e) matching, by the processing device, the one or more available paths with each of the plurality of potential riders and one or more of the plurality of drivers.

9. The method for generating one or more available paths according to claim 6, wherein an available path includes a ride-share route and a fixed route of transportation.

10. The method for generating one or more available paths according to claim 6, wherein step d) generates a first fest of available paths which are matched with a first subset of the potential riders, and subsequently, step d) generates a second set of available paths which are matched with a second subset of the potential riders.

11. The method for generating one or more available paths according to claim 10, wherein step d) is performed iteratively until a global cost function associated with the matched available paths is one of minimized and below a predetermined threshold.

12. The method for generating one or more available paths according to claim 6, wherein step d) generates a first set of available paths which are matched with a first set of available paths which are matched with a first subset of the potential riders and, concurrently, step d) generates a second set of available paths which are matched with a second subset of the potential riders.

13. A computer program product comprising a non-transitory recording medium storing instructions for performing the method of claim 6, and a processor in communication with the memory which implements the instructions.

14. A system comprising memory storing instructions for performing the method of claim 6, and a processor in communication with the memory which implements the instructions.

15. A ride-sharing path generation system comprising:
a trip planning platform configured to generate one or more paths associated with a transportation network including one or more fixed routes of transportation associated with one or more of buses, trains, bikes, walking paths and trams;
a driver ride-share information receiving component configured to receive ride-share information from a plurality of drivers offering to ride-share, the ride-share information including, for each driver, a driver desired departure location and time/date, and a driver desired arrival location and time/date;
a virtual vehicle mapping component configured to map the ride-share information to virtual vehicle routes within the transportation network including one or more ride-share fixed routes, each of the ride-share fixed routes associated with a respective driver desired departure location and driver desired departure time/date, and the respective driver desired arrival location and driver desired arrival date/time;
a rider request component configured to receive a request from a plurality of potential riders to determine one or more available paths between a rider origin location and a rider destination location desired by each of the respective potential riders within the transportation network; and
a path generation component configured to generate the one or more available paths within the transportation network, the one or more available paths including one or more of the virtual vehicle routes and the one or more available paths associated with available paths that are calculated to have a minimal cost, the cost associated with one of arrival time of the potential rider at the rider destination location, duration of travel of the potential rider to the rider destination location, number of routes associated with travel of the potential rider to the rider destination location, distance of travel of the potential rider to the rider destination location, and monetary cost of travel of the potential rider to the rider destination location.

16. The ride-sharing path generation system according to claim 15, wherein the system is configured to generate one or more potential meeting locations for the one or more of the plurality of drivers and one or more respective potential riders, the meeting locations provided by demand centroids based on origin-destination historical data.

17. The ride-sharing path generation system according to claim 15, further comprising:
a matching component configured to match the one or more available paths with each of the plurality of potential riders and one or more of the plurality of drivers.

18. The ride-sharing path generation system according to claim 15, wherein an available path includes a ride-share route and a fixed route of transportation.

19. The ride-sharing path generation system according to claim 15, wherein the path generation component is configured to generate a first set of available paths which are matched with a first subset of the potential riders, and subsequently, generate a second set of available paths which are matched with a second subset of the potential riders.

20. The ride-sharing path generation system according to claim 19, wherein the path generation component is configured to iteratively match potential riders until a global cost function associated with the matched available paths is one of minimized and below a predetermined threshold.

21. The ride-sharing path generation system according to claim 15, wherein the path generation component is configured to generate a first set of available paths which are matched with a first subset of the potential riders and, concurrently, generate a second set of available paths which are matched with a second subset of the potential riders.
